(19) United States
(12) Patent Application Publication
(10) Pub. No.: US 2013/0077809 A1
(43) Pub. Date: Mar. 28, 2013

(54) WASHING MACHINE

(71) Applicant: Young Bae Park, Changwon-si (KR)

(72) Inventor: Young Bae Park, Changwon-si (KR)

(21) Appl. No.: 13/574,388

(22) PCT Filed: Jan. 21, 2011
(86) PCT No.: PCT/KR2011/000417

§ 371 Date: Nov. 21, 2012

(30) Foreign Application Priority Data
Jan. 22, 2010 (KR) 1020100006146

(51) Int. Cl. G10K 11/18

(52) U.S. Cl. CPC G10K 11/18
USPC 381/332

(57) ABSTRACT

The present invention relates to a washing machine in which the quality of a signal sound containing information on the washing machine is improved, wherein said signal sound is outputted by a signal sound output unit. More particularly, the present invention relates to a washing machine, comprising: the signal sound output unit which outputs, in a signal sound, information on the washing machine; and a signal sound guide unit which is arranged along the periphery of the signal sound output unit to form a sound path between the signal sound output unit and the signal sound guide unit, wherein one end of the signal sound guide unit is for reflecting the signal sound outputted by the signal sound output unit, and the other end thereof is open so as to output the signal sound transmitted through the sound path.

### TECHNICAL FIELD

The present invention is directed toward a washing machine that outputs information on the washing machine (hereinafter, “product information”) in the form of a sound, and particularly to a washing machine that has enhanced quality of a signal sound containing product information.

### BACKGROUND ART

When in a predetermined operation, a washing machine stores settings for performing the operation, information generated during the operation, and failure information and particularly outputs a predetermined alarm when encountered with a failure so that its user may notice its condition. The washing machine sometimes outputs specific failure information, e.g., through a display means or lamp which is provided in the washing machine as well as simply alerts the completion of the operation or the occurrence of a failure.

Meanwhile, when the washing machine malfunctions, a user attempts to contact a customer service center to consult them or to ask for help.

In general, when a failure takes place, such washing machine merely outputs alerts by which a user can notice the failure or outputs an error code that the user cannot recognize, which renders the user to respond to the failure, and even when he can reach a customer service center, it is hard to let them know exactly what's going on with the washing machine. So, a service person cannot grasp exact cause of the failure, and thus consumes a lot of time and expense to repair it. For example, if parts necessary to fix the broken washing machine are not ready in advance, the service person needs to revisit the home, which leads to bother and time consumption.

To address the above problems, there is a need for exactly outputting production information of the washing machine in the form of a sound and transferring the product information to the customer service center.

### DISCLOSURE

### Technical Problem

An object of the present invention is to provide a washing machine, which when turning product information of the washing machine into a sound signal and outputting the sound signal, may provide increased quality of the output sound signal.

### Technical Solution

A washing machine according to the present invention includes a signal sound output unit that outputs product information as a sound signal and a signal sound guide unit that is formed along a circumference of the signal sound output unit and forms a sound path between the signal sound guide unit and the signal sound output unit, wherein the signal sound guide unit includes at an end thereof a reflecting end to reflect a signal sound output from the signal sound output unit and at another end thereof an opened end through which a signal sound transferred through the sound path is output.

The signal sound guide unit includes a first rib connected to the reflecting end and a second rib connected to the opened end, wherein a width of a sound path section formed between the first rib and the signal sound output unit is smaller than a width of a sound path section formed between the second rib and the signal sound output unit.

The washing machine according to the present invention further includes a casing that forms an outer appearance of the washing machine, wherein the signal sound output unit is provided at a rear surface of the casing, and the signal sound guide unit is formed to protrude from the rear surface of the casing. The washing machine further includes an opening formed in the casing, wherein the opened end of the signal sound guide unit communicates with the opening. The washing machine further includes an input unit that is mounted in the casing and receives various control commands from a user, wherein the opening is a gap that is formed when the input unit is mounted in the casing.

The signal sound guide unit includes a first rib connected to the reflecting end and a second rib connected to the opened end, wherein a width of a sound path section formed between the first rib and the signal sound output unit is smaller than a width of a sound path section formed between the second rib and the signal sound output unit. The signal sound guide unit further includes a third rib that connects the first rib with the second rib, and wherein the third rib includes a section with a curved surface that allows a sound transferred from the reflecting end to be reflected toward the opened end.

The section with the curved surface is formed at where the third rib is connected to the first rib or at where the third rib is connected to the second rib. The signal sound output unit outputs the product information as signal sounds including a plurality of different frequencies. The washing machine further includes a controller that encodes the product information and generates a control signal and a modulator that transforms different bits constituting the control signal applied from the controller into different frequency signals, respectively, wherein the signal sound output unit outputs a predetermined signal sound corresponding to the frequency signals applied from the modulator.

Alternatively, a washing machine includes a signal sound output unit that outputs production information as a sound signal and a signal sound guide unit that is formed as a rib along a circumference of the signal sound output unit and forms a sound path between the signal sound guide unit and the signal sound output unit, wherein a reflecting end is formed at an end of the rib, and an opened end is formed at another end of the rib, and wherein the signal sound guide unit guides a sound signal reflected by the reflecting end toward the opened end, and wherein the signal sound guide unit includes a first rib connected to the reflecting end and a second rib connected to the opened end, and wherein a sound pressure in a sound path formed between the first rib and the signal sound output unit is higher than a sound pressure in a sound path formed between the second rib and the signal sound output unit.

In the signal sound guide unit, a width of a sound path section formed between the first rib and the signal sound output unit is smaller than a width of a sound path section formed between the second rib and the signal sound output unit. The signal sound guide unit further includes a third rib that connects the first rib with the second rib, and wherein the third rib includes a section with a curved surface that allows a sound transferred from the reflecting end to be reflected toward the opened end. The section with the curved surface is formed at where the third rib is connected to the first rib. The section with the curved surface is formed at where the third rib is connected to the second rib.

### Advantageous Effects

The washing machine according to the present invention has the effect of being able to enhance quality of a signal sound containing the product information output to the outside of the washing machine.

Further, the washing machine according to the present invention has the effect of being able to exactly transfer the product information of the washing machine through a signal sound.

Still further, the washing machine according to the present invention allows a signal sound to be output to the outside through a gap formed in the casing, thus eliminating the need to provide a separate configuration for outputting the signal sound.

Yet still further, the washing machine according to the present invention guides a signal sound along a predetermined direction and outputs the signal sound, thus reducing the likelihood of occurrence of errors due to spread of the signal sound while the signal sound is transferred.

### DESCRIPTION OF DRAWINGS

FIG. 1 is a view illustrating a configuration of a washing machine and a diagnosing system including the washing machine according to an embodiment of the present invention.

FIG. 2 is a perspective view illustrating a washing machine according to an embodiment of the present invention.

FIG. 3 is a side cross sectional view illustrating an inner structure of the washing machine illustrated in FIG. 2.

FIG. 4 is a block diagram illustrating a configuration to control a washing machine according to an embodiment of the present invention.

FIG. 5 is a conceptual view illustrating a process of turning product information of a washing machine into a frequency signal according to an embodiment of the present invention.

FIG. 6 illustrates a control panel of a washing machine according to an embodiment of the present invention.

FIG. 7 illustrates a control panel frame included in the control panel illustrated in FIG. 6.

FIG. 8 is an expanded view illustrating a portion of the control panel illustrated in FIG. 7.

FIGS. 9 and 10 are expanded views illustrating a rear surface of the portion of the control panel illustrated in FIG. 8.

FIGS. 11 to 13 illustrate paths along which signal sounds output from a buzzer are transmitted according to positions where the signal sounds are generated.

FIG. 14 illustrates paths along which signal sounds are transmitted when the signal sound guide unit illustrated in FIGS. 11 to 13 has a different configuration.

### BEST MODE

The advantages and features of the present invention and methods for achieving the advantages and features will be apparent by the embodiments described in detail with reference to the accompanying drawings. However, the present invention is not limited to the embodiments and may be implemented in various configurations. The embodiments are provided to make the invention thoroughly disclosed and to inform those skilled in the art of the category of the invention, and the invention is defined only by the accompanying claims. The same reference denotations refer to the same elements throughout the specification.

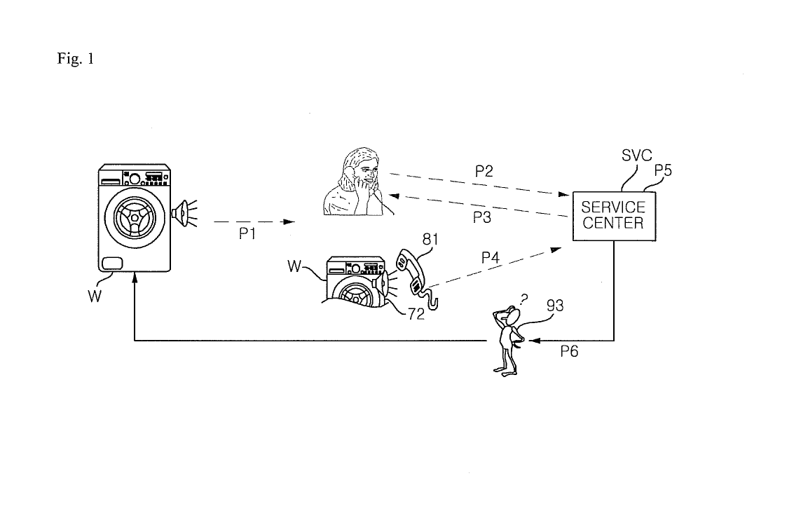

FIG. 1 is a view illustrating a configuration of a washing machine and a diagnosing system including the washing machine according to an embodiment of the present invention.

Referring to FIG. 1, the washing machine of the present invention is included in the diagnosing system, and the conditions of the washing machine or whether a failure happens to the washing machine may be diagnosed by a service center of the diagnosing system. The service center includes a diagnosing server that has information on the washing machine and a diagnosing program.

If a washing machine W in each home produces information on its operation in the form of a sound, a signal sound including product information is transmitted to the service center SVC via a telephone network so that the diagnosing system of the washing machine may diagnose whether the washing machine is encountered with a failure.

The washing machine W includes a display unit to display predetermined data, and the display unit, which includes a light emission body, such as LEDs, LCDs, or OLEDs, visualizes and displays information on the condition information or failure information of the washing machine W. Further, the washing machine W includes a signal sound output unit as a means to output a sound and replays information on the operation, condition, and failure of the washing machine W and outputs the information as a predetermined signal sound.

When breaking down or malfunctioning in operation, the washing machine W alerts a user to occurrence of a failure through the display unit or the signal sound output unit (P1).

At this time, the user verifies the product information of the washing machine W that is displayed on the display unit and controls the operation of the washing machine W or attempts to contact the service center SVC to let them know the failure and to inquire about any measures (P2).

When the user contacts the service center SVC and in response the service center SVC requests the user to manipulate a selection unit among input units included in the washing machine, wherein a command for performing failure diagnosing is input to the selection unit, the washing machine W turns the product information into a predetermined sound and outputs the sound through the signal sound output unit. The thusly output signal sound containing the production information is transmitted to the service center through a communication network (P4).

At this time, the user transmits the signal sound containing the product information of the washing machine by using a terminal 81, such as a portable terminal or telephone—for example, by bringing his telephone 81 close to a part of the washing machine W through which a sound emanates, that is, the signal sound output unit, while he's on the phone to notify the service center SVC of the model information and what's happening to the washing machine as the result of the failure. The signal sound output unit may be configured as a sound output means such as a buzzer or speaker.

Receiving the signal sound through the communication network, e.g., a telephone network, connected thereto, the service center STV analyzes the signal sound and determines the condition of the washing machine W and diagnoses whether a failure has occurred to the washing machine (P5). The service center SVC dispatches a service person 93 to the home to provide a proper service to the user (P6). At this time, results of the diagnosis are transmitted to the service person's terminal (P6) so that the service person 93 can fix the failure of the washing machine W. As is often case, the service center SVC may be connected to the user via a communication network so that an operator can transfer the diagnosed results to the user in voice or in the form of predetermined data. Further, the diagnosed results may be transferred to the user's email or the terminal 81.

The diagnosing system may analyze the signal sound containing the product information which is transmitted to the service center SVC through a predetermined communication network, e.g., a telephone network, and may precisely judge whether the washing machine W broke out, which enables the washing machine to be swiftly treated.

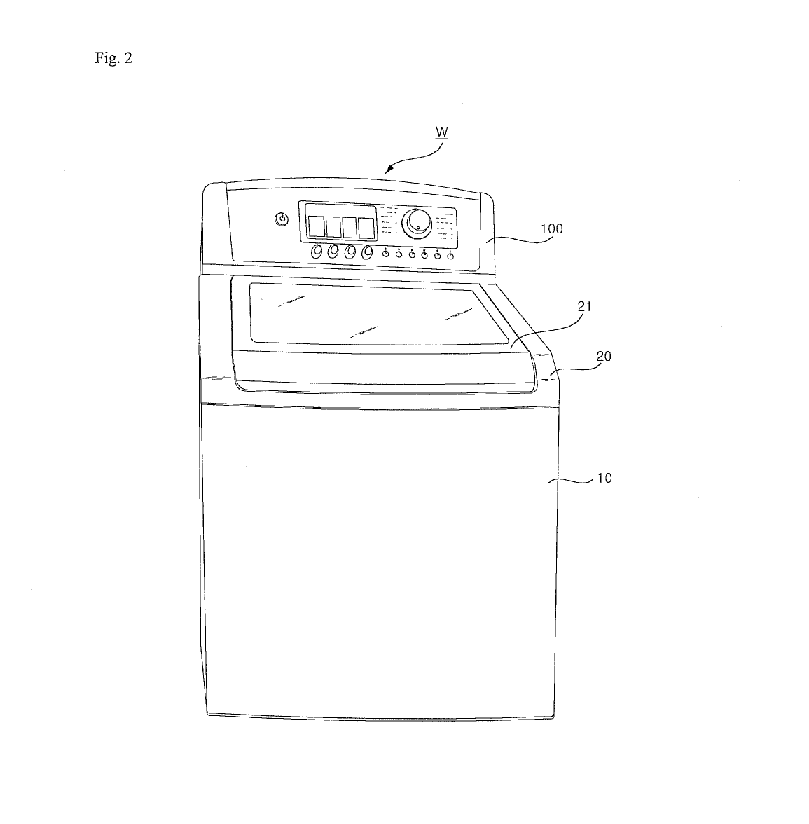

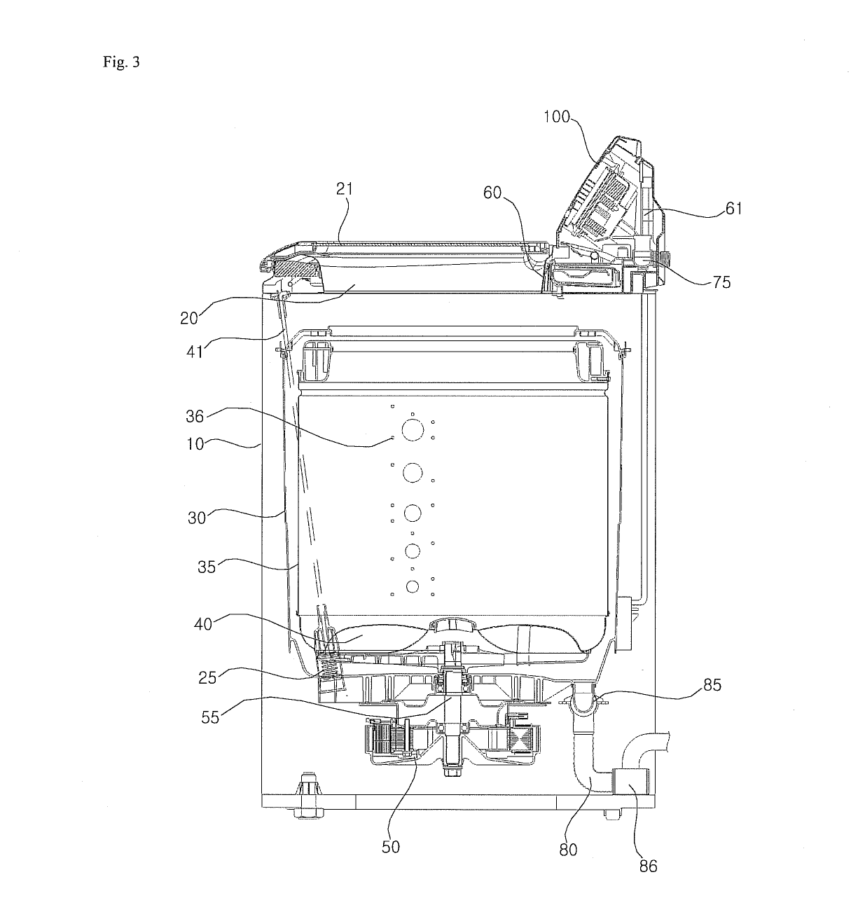

FIG. 2 is a perspective view illustrating a washing machine according to an embodiment of the present invention. FIG. 3 is a side cross sectional view illustrating an inner structure of the washing machine illustrated in FIG. 2. Referring to FIGS. 2 and 3, the washing machine W according to an embodiment of the present invention includes a casing forming an outer appearance and a signal sound output unit provided inside the casing to output product information on the washing machine W in the form of a signal sound.

The casing includes a cabinet 10 having an opening at its top, a top cover 20 coupled with an upper portion of the cabinet 10 and having a laundry entrance/exit hole through which laundry is put in or pulled out, and a control panel 100 coupled with the top cover 20 and providing a user interface, wherein the control panel 100 includes an input unit to receive various control commands for the overall operation of the washing machine W from a user and an output unit to display information on the overall operation condition of the washing machine W.

The washing machine W also includes a door 21 rotating coupled with the top cover 20 to open and close the washing machine entrance/exit hole, an outer tub 30 hung to the top cover 20 by a supporting member 41 and to contain washing water, a damper 25 coupling the supporting member 41 to the outer tub 30 and alleviating vibrations that are generated during the operation of the washing machine W, an inner tub 35 rotatably provided in the outer tub 30 and receiving laundry, a pulsator 40 rotatably provided at a lower portion of the inner tub 35, and a driver including a driving means such as a motor 50 to provide a driving force to the inner tub 35 and/or the pulsator 40. A rotational force generated by the motor 50 is transferred to the inner tub 35 and/or the pulsator 40 via a rotational shaft 55.

In the top cover 12 may be withdrawably provided a detergent box 60 that receives various washing agents, such as washing detergent, fabric softener for rinsing, and/or bleach. A water supply path 61 is connected to an external water source, such as a water faucet, to feed washing water to the inner tub 35 and the outer tub 30. At this time, the inner tub 35 includes a plurality of pores 36 through which washing water flows between the inner tub 35 and the outer tub 30. Meanwhile, a water supply valve 75 may be further provided to switch on/off the water supply path 61.

The washing machine W may further include a water drainage path 80 to discharge washing water contained in the outer tub 30 to the outside and a pump 86 and a water drainage valve 85 provided on the water drainage path 80.

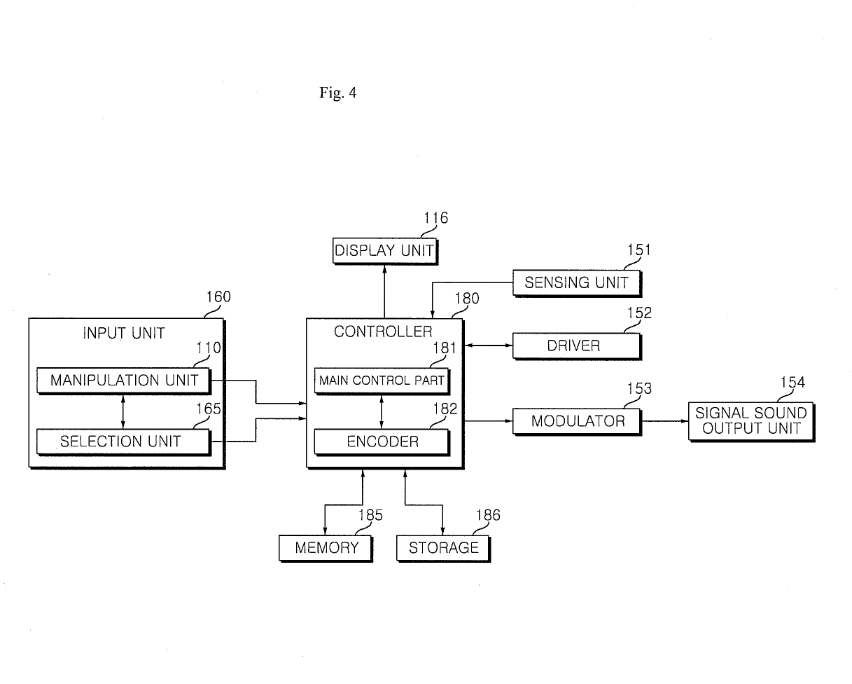

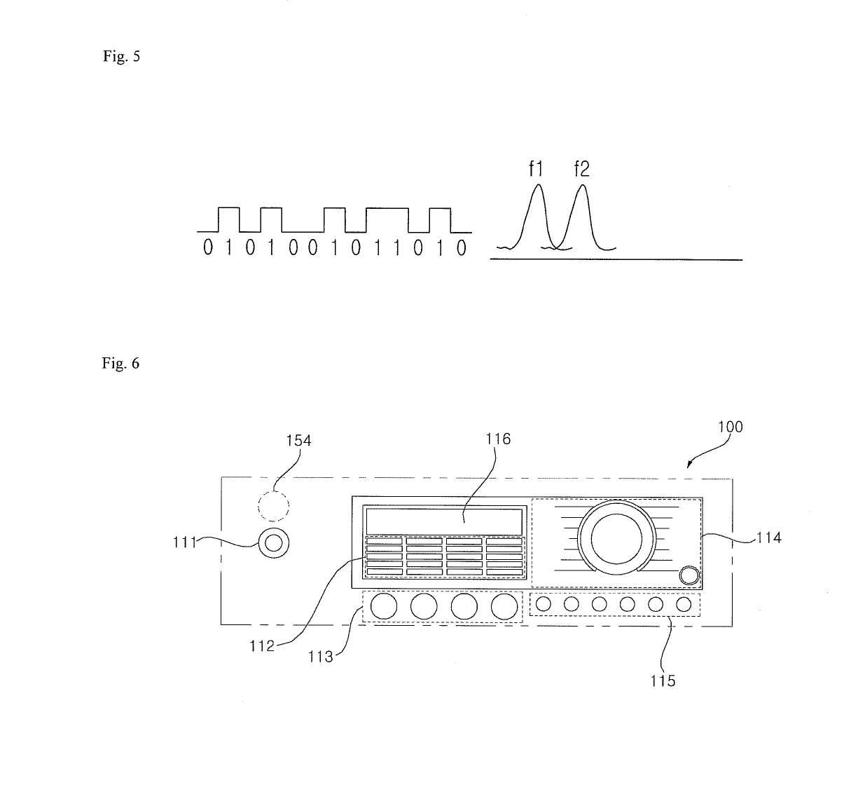

FIG. 4 is a block diagram illustrating a configuration to control a washing machine according to an embodiment of the present invention. FIG. 5 is a conceptual view illustrating a process of turning product information of a washing machine into a frequency signal according to an embodiment of the present invention.

Referring to FIG. 4, the washing machine W may include an input unit 160, a display unit 116, a sensing unit 151, a memory 185, a storage 186, a driver 152, a modulator 153, a signal sound output unit 154, and a controller 180 that controls the overall operation of the washing machine.

The input unit 160 includes at least one input means to input various control commands for controlling the operation of the washing machine W by the user's manipulation and includes a manipulation unit 110 that is generally provided to receive a control command to operate the washing machine W and a selection unit 165 that receives a control command to perform a failure diagnosing mode.

The selection unit 165 includes at least one input means, and when entry to a failure diagnosing mode is selectively input through the input means, a signal output command is applied to the controller 180 so that the product information is output as a predetermined signal sound through the signal sound output unit 154.

At this time, the selection unit 165 may be implemented as a predetermined input means separately from the manipulation unit 110, but in some cases, two or more manipulation keys may be simultaneously manipulated to operate as the selection unit 165 or to be recognized as the selection unit 165.

Further, as enters into the failure diagnosing mode, the selection unit 165 enables the signal sound output unit 154 to turn on/off. That is, if a signal output command is input by the selection unit 165, the product information is output as a predetermined signal sound in response to a control signal of the controller 180. At this time, the signal sound output unit 154 operates to output a signal sound.

A user may input control commands such as setting an operating course or setting an operation through the manipulation unit 110, and the control command is applied to the controller 180. Further, the manipulation unit 110 may receive a setting according to the output of the signal sound. For example, the manipulation unit 110 may receive a setting value to set how to output a signal sound and the size of the output signal sound.

At this time, the input unit 160, such as the selection unit 165 and the manipulation unit 110, may include a button, a dome switch, a touch pad (capacitive/resistive), a jog wheel, a jog switch, a finger mouse, a rotary switch, or a jog dial, and any device may apply to the input unit 160 as long as it may generate predetermined input data when pressed, rotated, pressurized, contacted, or by other types of manipulation.

The sensing unit 151 includes at least one sensor that senses a temperature, pressure, voltage, current, water level, or revolution count and applies sensed or measured data to the controller 180. For example, the sensing unit 151 measures the level of water upon water supply or water drainage and may measure the temperature of the supplied water or the revolution speed of the washing tub or drum.

The driver 152 controls the operation of the washing machine W so that the washing machine performs a set operation in response to a control signal from the controller 180. For example, the driver 152 may drive the motor 50 and control the operation of the motor 50 so that the inner tub 35 and/or the pulsator 40 rotate to wash laundry.

The memory 185 stores control data for controlling the operation of the washing machine W and reference data to be used while the operation of the washing machine is controlled.

At this time, the memory 185 includes a data storage, such as a ROM or an EEPROM, to store control data of the washing machine. The storage 186 is a buffer of the controller 180 to temporarily store data, which may be a DRAM or SRAM, and in some cases, the storage 186 is included in the controller 180 or the memory 185.

When the washing machine W performs a predetermined operation, the memory 185 stores operation condition data that is generated during the operation, operation information, such as setting data input by the manipulation unit 110 so that the washing machine W conducts a predetermined operation, a usage information including the number of times by which the washing machine W carries out a particular operation and model information of the washing machine, and failure information including information on the cause or position of malfunction that occurs when the washing machine W operates.

That is, the memory 185 stores product information including the operation information, usage information, and failure information. The storage 186 also stores temporary data for the failure information and operation information that occur during the operation. For example, the product information may include the number of times by which the washing machine has been used, set courses, information on set options, error codes, values measured by the sensor, data produced from the controller, and operation information of each part.

The operation information may include information necessary for operating the washing machine, such as information on the washing cycle of the washing machine, information on the rinsing cycle, and information on the dehydrating cycle.

Further, the failure information may include various types of information, such as information on failures that occur during each operation of the washing machine, information on failures of the washing machine itself, error codes corresponding to the failure information, information of the controller 180, values sensed by the sensing unit 151, values sensed by the motor, failure information of a washing water supplying device, or failure information of a water drainage device.

The usage information may include various types of information, such as the number of times by which a user has used the washing machine, a course set by the user, or information on options set for the washing machine. That is, the usage information may include what is input to the washing machine by the user or information initially set to the washing machine.

When a predetermined control command is input through the selection unit 165 to request entry into the failure diagnosing mode, the controller 180 calls the product information stored in the memory 185 or the storage 186 and generates a predetermined format of a control signal and applies the generated control signal to the modulator 153. At this time, the controller 180 performs control that enables the signal sound output unit 154 to operate.

The controller 180 includes a main control part 181 that controls the flow of data that is input to or output from the washing machine and generates and applies a control command according to data input from the sensing unit 151 or transfers the sensed data to the driver 152 so that the washing machine operates and an encoder 182 that turns the product information into a control signal of a predetermined format so as to output a sound according to an input from the selection unit 165.

The main control part 181 enables a start sound to be output through the signal sound output unit 154 to alert the onset of a failure diagnosing mode when the selection unit 165 is input and enters into the failure diagnosing mode, and enables predetermined data to be displayed through the display unit 116 to alert the execution of the failure diagnosing mode.

Further, when the control signal generated by the encoder 182 is applied to the modulator 153 and a sound is output through the signal sound output unit 154, the main control part 181 may control the signal sound output unit 154 so that the signal sound output unit 154 outputs predetermined alert sounds before and after the sound is output. In some cases, the output of the alert sound may be omitted.

At this time, when two or more signal sound output units 154 are provided, the main control part 181 controls the signal sound output unit 154 so that the alert sound and the sound containing the product information are output through the different signal sound output units 154, respectively. Upon entry into the failure diagnosing mode, the main control part 181 stops the manipulation unit 110 except for the selection unit 165 and the power key from operating and may control the sensing unit 151 and the driver 152 so that the washing machine stops all of the other operations.

Further, when any one manipulation key of the manipulation unit 110 is entered according to an operation setting of the washing machine after power-on, the main control part 181 may stop the failure diagnosing mode from initiating even when the selection unit 165 is input. In particular, in the case that without providing a separate selection unit 165 the selection unit 165 is recognized as being input by a combination of two or more of the plurality of manipulation keys of the manipulation unit 110, the main control part 181 enables the failure diagnosing mode to begin only when right after the input is done by the power key the selection unit 165 is input by a designated key combination without other inputs. This allows the failure diagnosing mode to initiate only when a user clearly intends to enter into the failure diagnosing mode, thus preventing unnecessary entry into the failure diagnosing mode due to erroneous manipulation of the manipulation unit 110.

The encoder 182 calls the product information stored in the memory 185 and encodes the production information according to a predetermined scheme and adds a preamble and an error check bit to the data signal, thereby generating a control signal of a predetermined format. The encoder 182 generates a control signal constituted of a plurality of symbols by encoding the product information.

Further, when generating the control signal, the encoder 182 splits the control signal to a predetermined size and frames it to thereby configure packets having a plurality of frames. Further, the encoder 182 may set an IFS (Inter Frame Space) so that a predetermined sound is not output between the frames of the control signal, and may set a dead time to a symbol in a section where data values change so as to eliminate the echo effect that is created due to charge/discharge of a capacitor and affects conversion of a next signal upon signal conversion.

When, with respect to a plurality of symbols constituting a control signal, the length of each symbol is “symbol time”, and with respect to sounds output through the signal sound output unit 154 corresponding to the symbols, the basic length of a frequency signal constituting the sound is also the symbol time, the encoder 182 may set a dead time within the symbol time with respect to one symbol. At this time, the dead time varies in size according to the length of the symbol time.

Here, the product information includes operation information including operation settings or operation conditions during the operation, usage information, and failure information on malfunctions as described above. The product information is data constituted of combinations of 0 or 1 and is a digital signal that has a format readable by the controller 180.

The controller 180 categorizes the data of the product information, enables particular data for operating the washing machine to be included, divides or combines it to a predetermined size to generate a control signal of a designated standard and applies the control signal to the modulator 153.

In response to a control signal applied to the controller 180, the modulator 153 applies a predetermined driving signal to the signal sound output unit 154 so that a signal sound is output. The output signal sound includes the product information.

With respect to the symbols constituting the control signal, the modulator 153 applies the signal to the signal sound output unit 154 so that a frequency signal designated corresponding to one symbol is output during the symbol time. At this time, among the combinations of the symbols constituting the control signal, a frequency designated corresponding to data “1” and a frequency designated corresponding to data “0” have different frequency bands.

That is, the modulator 153 sets output of the signal sound containing the product information using a plurality of frequency bands and according to the number of the frequencies used for output of the signal sound changes the number of symbols per frequency signal and outputs the changed result.

In other words, when two frequencies are used, one frequency signal per symbol may be output during the designated time, and when four frequencies are used, one frequency signal may be output every two symbols of the control signal.

FIG. 5 illustrates an example where two frequencies are used, wherein a frequency signal of f1 is output corresponding to one symbol corresponding to data “1”, and a frequency signal of f2 is output corresponding to one symbol corresponding to data “0”. At this time, f1 may be 2.8 kHz, and f2 may be 2.6 kHz.

The modulator 153 has a frequency oscillator (not shown) to generate frequencies necessary for generating a signal sound, and the frequency oscillator generates a frequency signal designated corresponding to a control signal of the encoder 182.

The modulator 153 generates a frequency signal using any one of frequency shift keying, amplitude shift keying, and phase shift keying. Here, the frequency shift keying performs conversion into a signal of a predetermined frequency corresponding to a data value of a control signal, and the amplitude shift keying performs signal conversion so that the amplitude changes corresponding to a data value. The phase shift keying performs signal conversion so that the phase changes according to a data value.

Among frequency shift keying schemes, BFSK (Binary Frequency Shift Keying, hereinafter, “BFSK”) performs signal conversion to a first frequency when the data value of the control signal has a data value of 0 and performs conversion to a second frequency when the data value of the control signal has a data value of 1. For example, when the data value is 0, conversion to a signal having a frequency of 2.6 KHz is done, and when the data value is 1, conversion to a signal having a frequency of 2.8 KHz is done. Further, amplitude shift keying performs conversion to a signal having a frequency of 2.6 KHz, wherein when the data value of the control signal is 0, conversion to a signal having a frequency of 2.6 KHz and an amplitude of 1 is done, and when the data value may be done 1, conversion to a signal having a frequency of 2.6 KHz and an amplitude of 2 may be done.

Although it has been described that the modulator 153 employs frequency shift keying, the present invention is not limited. Further, the used frequency band is merely an example, and other frequency bands may be used as well.

When a dead time is set in the control signal, the modulator 153 stops signal conversion during the section where the dead time is set. At this time, when performing signal conversion using a pulse width modulation (PWM) scheme, the modulator 153 turns off the oscillation frequency for modulation during the section where the dead time is set so that the frequency signal conversion is temporarily paused during the dead time. Accordingly, a sound with echo effect between symbols removed is output through the signal sound output unit 154.

The signal sound output unit 154 outputs a predetermined signal sound containing the product information according to the frequency signal converted by the modulator 153.

At this time, at least one signal sound output unit 154 is provided, and preferably, two or more signal sound output units 154 may be provided. For example, when two signal sound output units are provided, a predetermined sound containing the product information may be output through one of the two signal sound output units, and a sound for alert or sound effect corresponding to the condition information of the washing machine may be output through the other one of the two signal sound output units, and further a sound to alert entry into the failure diagnosing mode or an alert sound before the sound is output may be output as well. The signal sound output unit 154 may include a means to output a sound, such as a speaker or buzzer.

Further, upon entry into the failure diagnosing mode, the signal sound output unit 154 may output a sound to alert the onset of the failure diagnosing mode in response to a control command from the main control part 181 and when the output of a sound containing the product information starts and terminates, respectively, the signal sound output unit 154 may output predetermined sounds.

The display unit 116 displays information input by the selection unit 165 and the manipulation unit 110, operation condition information of the washing machine W, and information generated as the operation of the washing machine is complete on the screen in response to a control command of the main control part 181. Further, when the washing machine malfunctions, the display unit 116 displays failure information on the malfunction on the screen.

When the failure diagnosing mode starts in response to a control command from the main control part 181, the display unit 116 displays that it is in the failure diagnosing mode and when a sound is output through the signal sound output unit 154, displays the progress in the form of at least one of a letter, an image, or a numeral.

At this time, the washing machine W may further include, in addition to the signal sound output unit 154 and the display unit 116, an output means, such as a lamp that flashes on or off or a vibrating device.

The washing machine W configured as above outputs a predetermined signal sound, and as described below, transfers the product information of the washing machine to the service center SVC.

When the product information of the washing machine W is output as a signal sound and transmitted to the service center SVC through a telephone network, the product information is input to a diagnosing server provided in the service center SVC to perform failure diagnosis on the washing machine W.

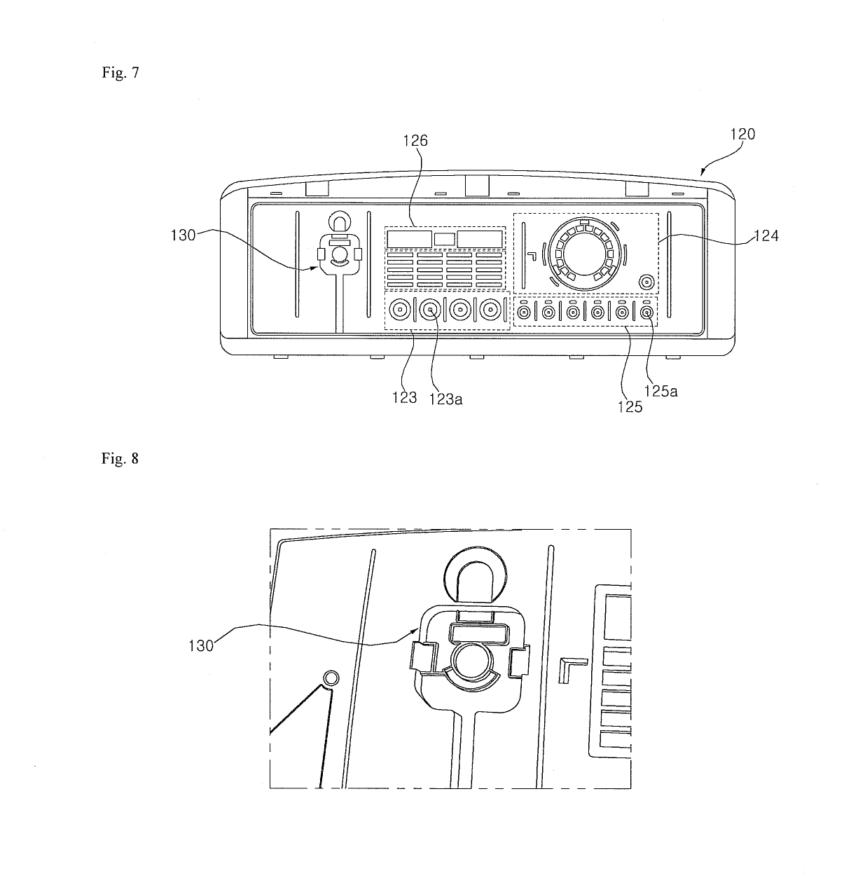

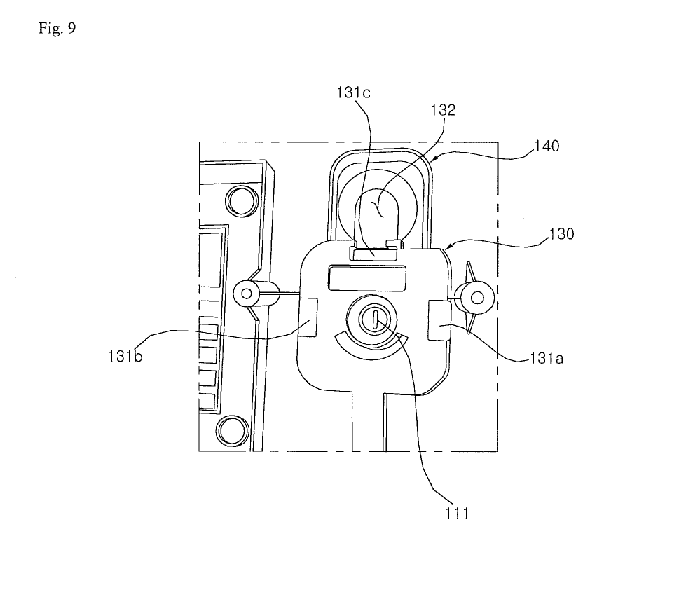

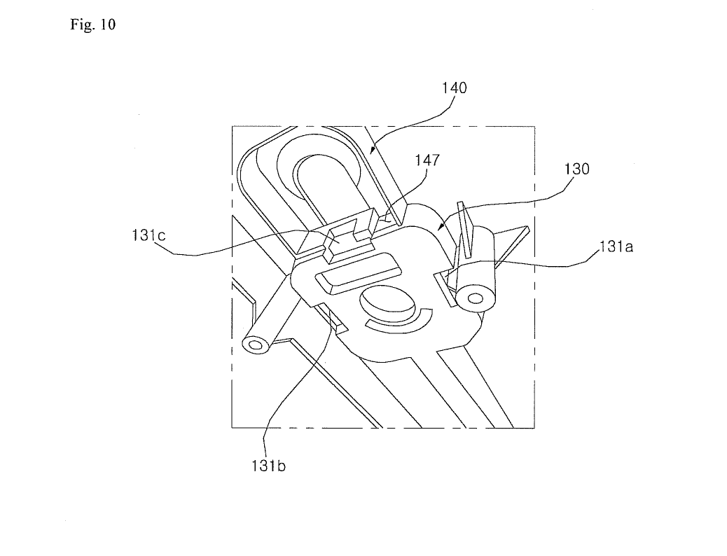

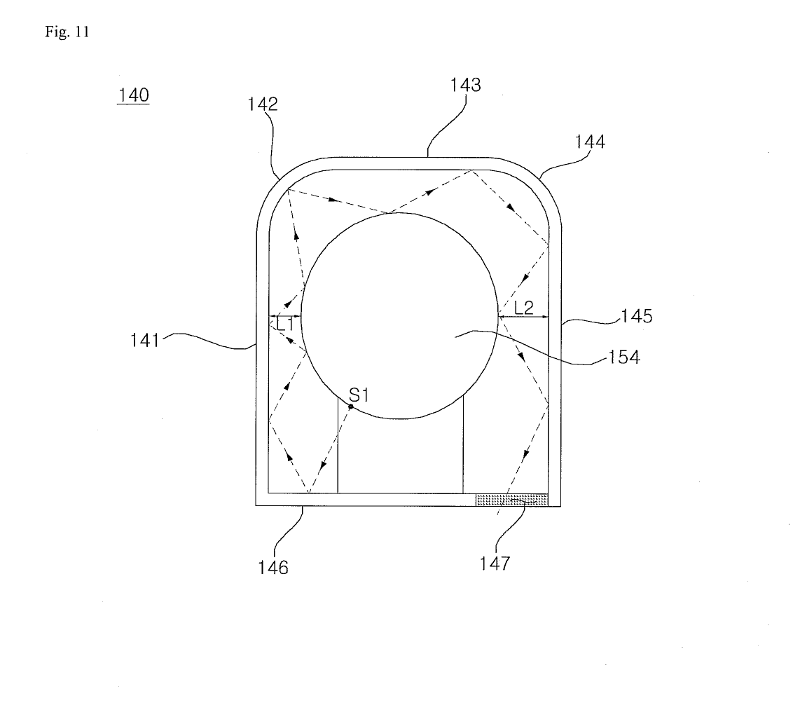

FIG. 6 illustrates a control panel of a washing machine according to an embodiment of the present invention. FIG. 7 illustrates a control panel frame included in the control panel illustrated in FIG. 6. FIG. 8 is an expanded view illustrating a portion of the control panel illustrated in FIG. 7. FIGS. 9 and 10 are expanded views illustrating a rear surface of the portion of the control panel illustrated in FIG. 8. FIGS. 11 to 13 illustrate paths along which signal sounds output from a buzzer are transmitted according to positions where the signal sounds are generated.

Referring to FIG. 4 and FIGS. 6 to 13, the washing machine W includes a sound signal output unit 154 that outputs product information as a sound signal and a signal sound guide unit 140 that is formed in the shape of a ring along the circumference of the signal sound output unit 154 to provide a sound path between the signal sound guide unit 140 and the signal sound output unit 154. The signal sound guide unit 140 includes a reflecting end to reflect a signal sound output from the signal sound output unit 154 at an end thereof and an open end where a signal sound transferred through the sound path is output at the other end thereof.

The signal sound output unit 154 may be implemented as a sound output means such as a buzzer or speaker and is provided in the casing of the washing machine. As described above in connection with FIGS. 2 and 3, the casing may include the control panel 100. Hereinafter, although the signal sound output unit 154 is described as being provided inside the control panel 100, the present invention is not limited thereto, and may be provided in the cabinet 10 or the top cover 20 constituting the casing of the washing machine W.

The signal sound guide unit 140 is provided at a rear surface of the casing. Hereinafter, although the signal sound guide unit 140 is provided at a rear surface of the control panel 100 corresponding to a structure where the signal sound output unit 154 is provided in the control panel 100, the present invention is not limited thereto and may be also provided in the cabinet 10 or the top cover 20 constituting the casing of the washing machine W.

The control panel 100 may include a control panel frame 120 and an ornamental panel attached to an upper portion of the control panel frame 120 to increase esthetic sense. Description on functions of various manipulation keys provided in the control panel 100 is printed on the ornamental panel.

The control panel frame 120 may include a display unit mounting unit 126 where the display unit 116 is mounted, a dial mounting unit 124 where a dial input unit 114 is mounted to set through a dial a washing course depending on the type of laundry or depending on the degree of contamination of laundry, a manipulation key mounting unit 123 where various manipulating keys 113 are mounted, such as a setting key to set the degree of contamination of laundry or a setting key to set the speed of dehydration, a manipulation key mounting unit 125 where manipulation keys 115 are mounted, such as an additional rinsing selection key, a user program setting key and/or a fabric softener introducing selection key, a power key mounting unit 130 where a power key 111 is mounted to turn on/off the washing machine W, and the signal sound guide unit 140 formed along the circumference of the signal sound output unit 154.

As described above, the signal sound output unit 154 may be implemented as a buzzer or a speaker. Hereinafter, it is described that the signal sound output unit 154 is a buzzer. The power key mounting unit 130 is formed to be depressed at a front surface of the control panel frame 120 so that the power key 111 may be mounted at the front surface of the control panel frame 120. Considering the structure in which the power key 111 is mounted in the power key mounting unit 130, and an ornamental panel (not shown) is attached onto the front surface of the control panel frame 120, the ornamental panel includes a hole to mount the power key 111 and a predetermined gap is provided between the power key 111 and the hole.

As long as the power key 111 is coupled to not fill up the grooved space formed by the power key mounting unit 130, it is apparent that a predetermined space is formed between the power key 111 and the power key mounting unit 130 to transmit a signal sound output from the signal sound output unit 154, and thus, once a sound path that may guide a signal sound output from the buzzer 154 to the power key mounting unit 130 is formed, the signal sound guided through the sound path may be effectively output to the outside of the washing machine W through a gap between the power key 111 and the control panel 100. An example of the gap between the power key 111 and the control panel 100 may be a gap between the power key 111 and the control panel frame 120 or between the power key 111 and the ornamental panel.

Referring to FIG. 9, since the power key 111 is hooked to coupling holes 131a, 131b, and 131c of the power key mounting unit 130, a predetermined space is formed between the power key 111 and the power key mounting unit 130.

On the other hand, a gap for outputting the signal sound as described above is formed to be able to output a signal sound output from the buzzer 154 to the outside while minimizing attenuation of the signal sound. For this, it may be also possible to form a separate opening in the control panel 100, and the structure suggested in this embodiment provides the effect of being able to enhance quality of a signal sound output to the outside of the washing machine W while utilizing, as is, a gap that is inevitably created due to the structure of installation of the button-type manipulation keys provided in the washing machine W.

In this embodiment, the buzzer 154 is provided inside the control panel 100, and a signal sound output from the signal sound output unit 154 is output to the outside of the washing machine W through the gap formed between the power key 111 and the control panel 100. However, unlike this, the signal sound may be also output through a gap formed between the control panel 100 and other manipulation keys provided in the control panel 100.

Referring to FIG. 11, the signal sound guide unit 140 is configured in the form of a rib that protrudes from a rear surface of the control panel 100. The signal sound guide unit 140 extends in the form of a ring along the circumference of the buzzer 154 to thereby prevent a signal sound output from the buzzer 154 from being spread and to thereby guide the signal sound to the side of the power key mounting unit 130.

A sound path is formed between the signal sound guide unit 140 and the buzzer 154, and the signal sound guide unit 140 includes a reflecting end to reflect a signal sound output from the signal sound output unit 154 at an end thereof and an opened end 147 to output the signal sound transferred through the sound path at the other end thereof.

On the other hand, it is preferred that the opened end 147 is formed to communicate with an opening (for example, a gap formed between the control panel 100 and the power key 111) formed in the casing of the washing machine W so that a signal sound output from the buzzer 154 may be directly transferred to the outside of the washing machine W through air vibration rather than transferred via a medium.

Further, the signal sound guide unit 140 includes a first rib 141 connected to the reflecting end 146 of the signal sound guide unit 140 and a second rib 145 connected to the opened end 147. At this time, it is preferred that the width L1 of the sound path section formed between the first rib 141 and the buzzer 154 is smaller than the width L2 of the sound path section formed between the second rib 145 and the buzzer 154.

The strength of a signal sound output through the opened end 147 may be enhanced as the ratio of the signal sound guided to the opened end 147 from the reflecting end 146 increases, and for this purpose, it is preferred to make the sound pressure in the sound path section formed between the first rib 141 and the buzzer 154 higher than the sound pressure in the sound path section formed between the second rib 145 and the buzzer 154. In this embodiment, the sound pressure in the sound path section formed between the first rib 141 and the buzzer 154 becomes higher than the sound pressure in the sound path section formed between the second rib 145 and the buzzer 154 by making the width L1 of the sound path section formed between the first rib 141 and the buzzer 154 smaller than the width L2 in the sound path section formed between the second rib 145 and the buzzer 154.

On the other hand, the signal sound guide unit 140 further includes a third rib 143 connecting the first rib 141 with the second rib 145, and the third rib 143 includes a section having a curved surface to allow a sound transferred from the reflecting end 146 to be reflected toward the side of the opened end 147. The section having the curved surface includes at least one of a first curved surface 142 formed at where the third rib 143 is connected to the first rib 141 and a second curved surface 144 formed at where the third rib 143 is connected to the second rib 145.

On the other hand, the control panel frame 120 may include a hole 132 corresponding to a position where the buzzer 154 is mounted, and part of a signal sound output from the buzzer 154 is transferred to the side of the power key mounting unit 130 through the hole 132.

The reference numerals 123a and 125a indicate mounts where the manipulation keys are mounted, and it is possible to output a signal sound to the outside of the washing machine W through a gap between the manipulation key and the mount.

Referring to FIG. 11, among signal sounds output from the buzzer 154, a signal sound output from a sound source S1 is reflected by the reflecting end 146 and travels toward the first rib 141, and is then alternately reflected by the first rib 141 and the buzzer 154 toward the first curved surface 142, and then reflected by the first curved surface 142 and then by the buzzer 154, the third rib 143, and the second rib 145, then travelling toward the side of the opened end 147.

In particular, it should be noted that in FIG. 11 the signal sound reflected by the reflecting end 146 is output through the opened end 147. Further, length L1 is smaller than length L2 to reduce the whole length of the travelling path of the signal sound reflected by the reflecting end 146 and to form a sound pressure gradient from the side of the reflecting end 146 toward the side of the opened end 147, thereby outputting the signal sound through the opened end 147 while minimizing the signal attenuation of the signal sound reflected by the reflecting end 146.

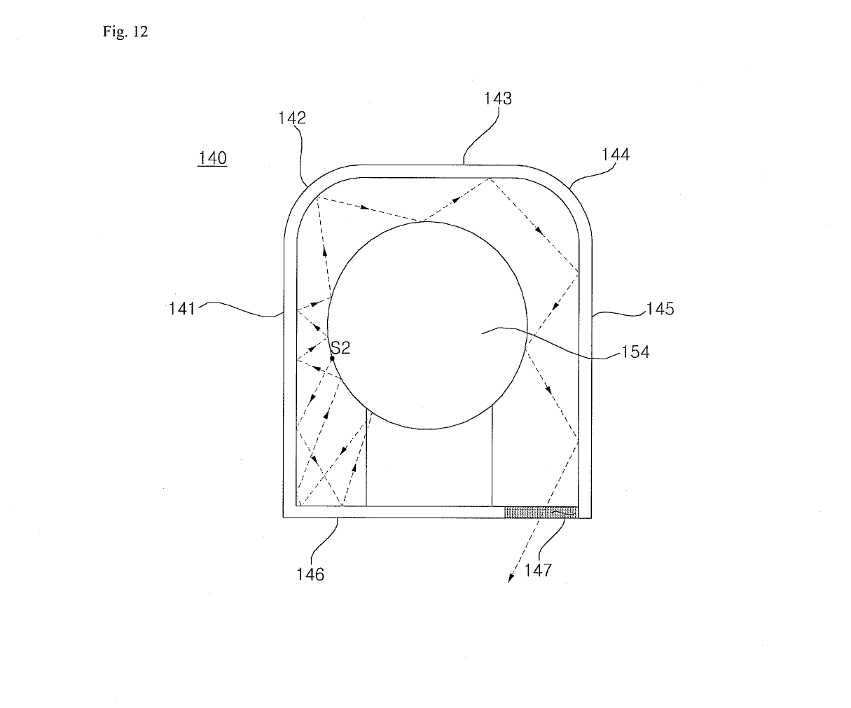

Referring to FIG. 12, unlike FIG. 11, a signal sound output from a sound source S2 is first reflected by the first rib 141 toward the reflecting end 146, reflected by the reflecting end 146 toward the buzzer 154, reflected by the buzzer 154 toward the reflecting end 146, and then reflected by the reflecting end 146. After the signal sound is reflected by the reflecting end 146, the travelling path of the signal sound is similar to what is illustrated in FIG. 11, and detailed description is omitted.

As described above, some of the signal sounds output from the buzzer 154 are reflected by the reflecting end 146 and thus output through the opened end 147. This leads to a characteristic that the amount of signal sound guided to the opened end 147 increases. On the contrary, in the case that the reflecting end 146 is opened, that is, assuming that both ends of the signal sound guide unit 140 are opened, the ratio of the signal source output from the sound source S1 or S2 and guided to the opened end 147 decreases, which may deteriorate quality of the signal sound output through the opened end 147.

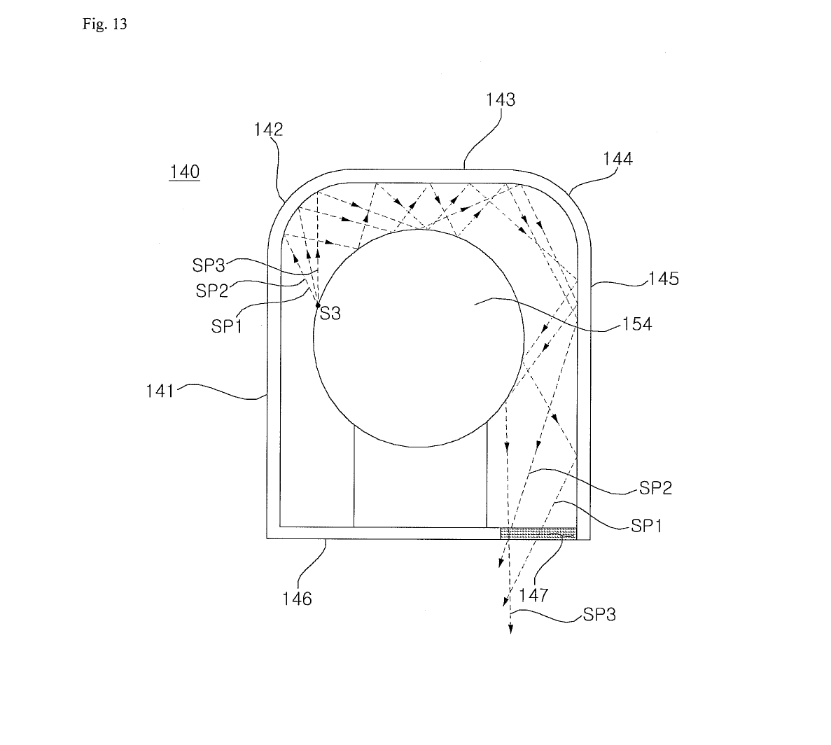

Referring to FIG. 13, signal sounds output from a sound source S3 travel along paths SP1, SP2, and SP3, respectively. No matter which path among the paths SP1, SP2, and SP3 the signal sounds follow, the signal sound reflected by the first curved surface 142 is guided to the side of the opened end 147. Accordingly, it can be seen that the structure of the first curved surface 142 helps increase the ratio of the signal sound guided from the side of the reflecting end 146 to the side of the opened end 147.

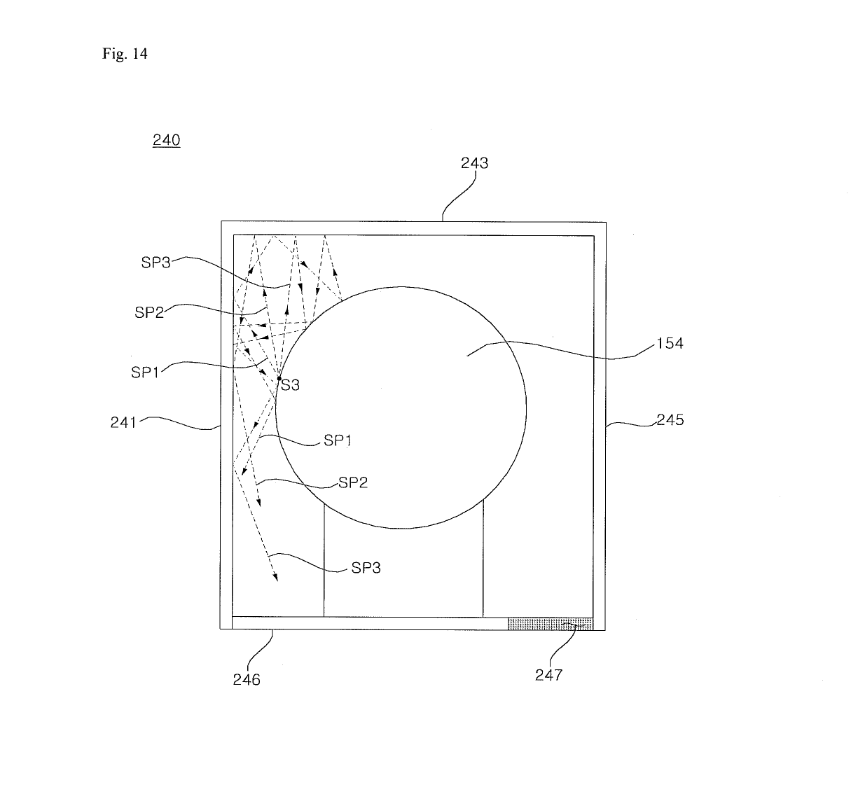

The effects of the first curved surface 142 may be more distinct from a comparison with the signal sound guide unit 240 illustrated in FIG. 14, which includes only the first rib 241, the second rib 245, the third rib 243, the reflecting end 246, and the opened end 247 without the first curved surface. Referring to FIG. 14, it can be seen that signal sounds output from the sound source S3 that is positioned at the same location as that illustrated in FIG. 13 and traveling along the paths SP1, SP2, and SP3, respectively, are guided to the side of the reflecting end 146 in contrast to what is illustrated in FIG. 13.

On the other hand, it is apparent that like the first curved surface 142, the second curved surface 144 also serves to enhance travel of the signal sound from the reflecting end 146 to the opened end 147.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A washing machine comprising:
a signal sound output unit that outputs product information as a sound signal; and
a signal sound guide unit that is formed along a circumference of the signal sound output unit and forms a sound path between the signal sound guide unit and the signal sound output unit, wherein the signal sound guide unit includes at an end thereof a reflecting end to reflect a signal sound output from the signal sound output unit and at another end thereof an opened end through which a signal sound transferred through the sound path is output.

2. The washing machine of claim 1, wherein the signal sound guide unit includes,
a first rib connected to the reflecting end; and
a second rib connected to the opened end, wherein a width of a sound path section formed between the first rib and the signal sound output unit is smaller than a width of a sound path section formed between the second rib and the signal sound output unit.

3. The washing machine of claim 1, further comprising a casing that forms an outer appearance of the washing machine, wherein the signal sound output unit is provided at a rear surface of the casing, and the signal sound guide unit is formed to protrude from the rear surface of the casing.

4. The washing machine of claim 3, further comprising an opening formed in the casing, wherein the opened end of the signal sound guide unit communicates with the opening.

5. The washing machine of claim 4, further comprising an input unit that is mounted in the casing and receives various control commands from a user, wherein the opening is a gap that is formed when the input unit is mounted in the casing.

6. The washing machine of claim 3, wherein the signal sound guide unit includes,
a first rib connected to the reflecting end; and
a second rib connected to the opened end, wherein a width of a sound path section formed between the first rib and the signal sound output unit is smaller than a width of a sound path section formed between the second rib and the signal sound output unit.

7. The washing machine of claim 6, wherein the signal sound guide unit further includes a third rib that connects the first rib with the second rib, and wherein the third rib includes a section with a curved surface that allows a sound transferred from the reflecting end to be reflected toward the opened end.

8. The washing machine of claim 7, wherein the section with the curved surface is formed at where the third rib is connected to the first rib.

9. The washing machine of claim 7, wherein the section with the curved surface is formed at where the third rib is connected to the second rib.

10. The washing machine of claim 1, wherein the signal sound output unit outputs the product information as signal sounds including a plurality of different frequencies.

11. The washing machine of claim 10, further comprising:
a controller that encodes the product information and generates a control signal; and
a modulator that transforms different bits constituting the control signal applied from the controller into different frequency signals, respectively, wherein the signal sound output unit outputs a predetermined signal sound corresponding to the frequency signals applied from the modulator.

12. A washing machine comprising:
a signal sound output unit that outputs production information as a sound signal; and
a signal sound guide unit that is formed as a rib along a circumference of the signal sound output unit and forms a sound path between the signal sound guide unit and the signal sound output unit, wherein a reflecting end is formed at an end of the rib, and an opened end is formed at another end of the rib, and wherein the signal sound guide unit guides a sound signal reflected by the reflecting end toward the opened end, and wherein the signal sound guide unit includes a first rib connected to the reflecting end and a second rib connected to the opened end, and wherein a sound pressure in a sound path formed between the first rib and the signal sound output unit is higher than a sound pressure in a sound path formed between the second rib and the signal sound output unit.

13. The washing machine of claim 12, wherein in the signal sound guide unit, a width of a sound path section formed between the first rib and the signal sound output unit is smaller than a width of a sound path section formed between the second rib and the signal sound output unit.

14. The washing machine of claim 13, wherein the signal sound guide unit further includes a third rib that connects the first rib with the second rib, and wherein the third rib includes a section with a curved surface that allows a sound transferred from the reflecting end to be reflected toward the opened end.

15. The washing machine of claim 14, wherein the section with the curved surface is formed at where the third rib is connected to the first rib.

16. The washing machine of claim 14, wherein the section with the curved surface is formed at where the third rib is connected to the second rib.
